(19) United States
(12) Patent Application Publication
(10) Pub. No.: US 2022/0291366 A1
(43) Pub. Date: Sep. 15, 2022

(54) UNDERWATER ULTRASONIC DEVICE

(71) Applicant: Qisda Corporation, Taoyuan City (TW)

(72) Inventors: Fu-Sheng JIANG, Taoyuan City (TW); Yi-Hsiang CHAN, Taoyuan City (TW); Hsin-Chih LIU, Taoyuan City (TW)

(73) Assignee: Qisda Corporation, Taoyuan City (TW)

(21) Appl. No.: 17/578,632

(22) Filed: Jan. 19, 2022

(30) Foreign Application Priority Data
Mar. 10, 2021 (CN) 202110259193.2

(51) Int. Cl. G01S 7/521; G01S 15/89

(52) U.S. Cl. CPC G01S 7/521; G01S 15/89

(57) ABSTRACT

An underwater ultrasonic device is disclosed. The underwater ultrasonic device comprises a body and an ultrasonic transducer. The ultrasonic transducer has a curved interface having a first side and an adjacent second side for transmitting and receiving a plurality of ultrasonic signals, and the first side has a first curve and the second side has a second curve, wherein the first curve and the second curve has different curvatures. Therefore, the underwater ultrasonic device can achieve the purpose of underwater wide-angle measurement with increased sensitivity and transmission capability.

### TECHNICAL FIELD

The present invention generally relates to an underwater ultrasonic device, in particular, an underwater ultrasonic device with a curvature for underwater wide-angle measurement.

### RELATED ART

In order to achieve wide-angle imaging, traditional underwater ultrasonic transducers often need to use multiple sets of ultrasonic transducers or splice together multiple ultrasonic transducers. However, when the splicing method is used, a large number of signal blind spots will be generated and measurement cannot be performed. In addition, since the transducer is usually of a long-strip shape and its narrow side also requires a wide-angle design, the size of the transducer's penetrating side limited.

Specifically, the ultrasonic transducer has twice the wavelength width and can form a 30-degree diffusion angle, which can increase the detection range in water. However, due to wave transmission, the size of the ultrasonic transducer is limited by the multiples of the wavelength, and the larger the wavelength, the smaller the diffusion angle. Conversely, when the size of the transducer is smaller, the diffusion angle is larger. The disadvantage is that the transducer needs to be driven by a higher voltage, and the receiving capability becomes worse.

### SUMMARY

Therefore, the present invention proposes an underwater ultrasonic device which mainly uses a transducer with a double-curvature arc surface to achieve the purpose of underwater wide-angle measurement with increased sensitivity and transmission capability.

One aspect of the present invention provides an underwater ultrasonic device. The underwater ultrasonic device includes an ultrasonic transducer and a body. The ultrasonic transducer is arranged on the body. The ultrasonic transducer has a curved interface for transmitting or receiving a plurality of ultrasonic signals. The curved interface has a first side and a second side adjacent to the first side. The first side has a first curve and the second side has a second curve, wherein the first curve and the second curve have different curvatures.

Another aspect of the present invention provides an underwater ultrasonic device. The underwater ultrasonic device includes an ultrasonic transducer and a body. The ultrasonic transducer is arranged on the body, and the ultrasonic transducer has a curved interface for transmitting or receiving a plurality of ultrasonic signals, wherein there is a first boundary line between a first side of the curved interface and a first virtual cross-section, and there is a second boundary line between a second side of the curved interface and a second virtual cross-section, and the first side is adjacent to the second side, wherein, at least one of the first boundary line and the second boundary line is a curve.

In order to further understand the features and technical content of the present invention, please refer to the following detailed descriptions and drawings about the present invention. However, the drawings provided are only for reference and description, and are not used to limit the present invention.

### BRIEF DESCRIPTION OF THE DRAWINGS

FIG. 1A shows the diagram of the ultrasonic transducer in connection with the body.

FIG. 1B shows the diagram of the ultrasonic transducer being separated from the body.

FIG. 2A shows a perspective view of the ultrasonic transducer.

FIG. 2B shows the top view of the ultrasonic transducer.

FIG. 2C shows the side view of the ultrasonic transducer.

FIG. 3A shows the diagram of the ultrasonic transducer in connection with the body.

FIG. 3B shows the diagram of the ultrasonic transducer being separated from the body.

FIG. 3C shows a boundary line of the underwater ultrasonic device of the present invention.

### DETAILED DESCRIPTION

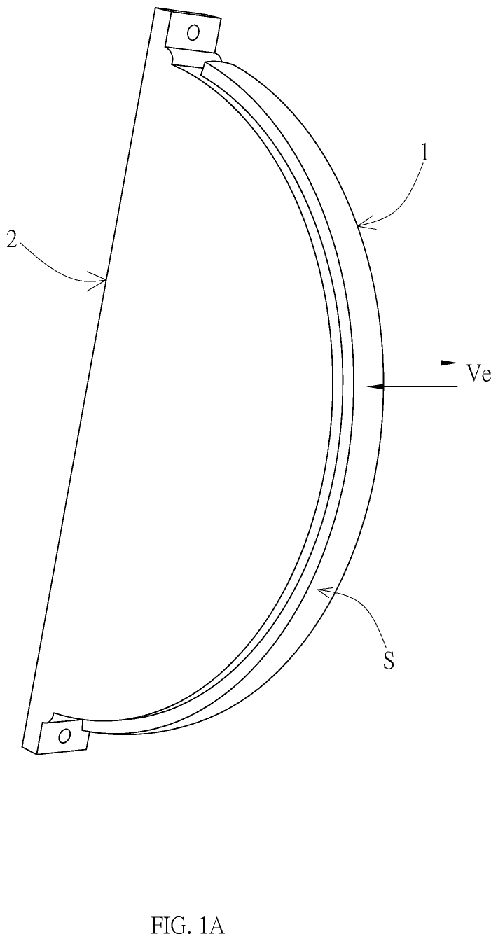

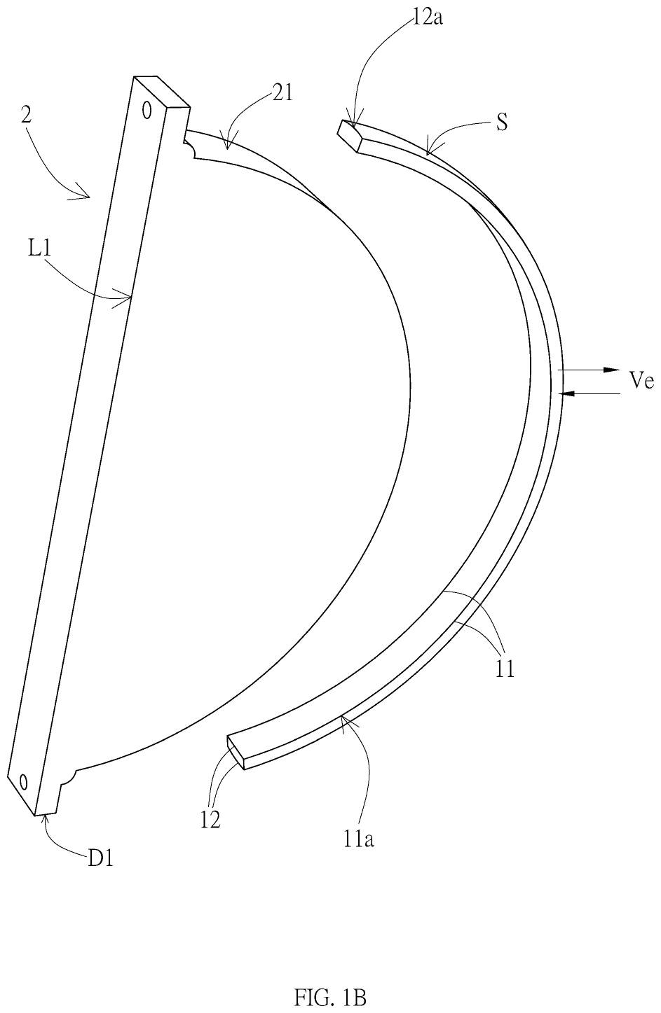

FIG. 1A and FIG. 1B show an underwater ultrasonic device according to an embodiment of the present invention. FIG. 1A shows the diagram of the ultrasonic transducer in connection with the body. FIG. 1B shows the diagram of the ultrasonic transducer being separated from the body. As shown in FIGS. 1A and 1B, the underwater ultrasonic device includes: an ultrasonic transducer 1 and a body 2. Preferably, the body 2 has a supporting surface 21, and the ultrasonic transducer 1 is disposed on the supporting surface 21 and transmits and receives signals on the side opposite to the supporting surface 21, wherein the supporting surface can be a flat surface or an arced surface. The ultrasonic transducer 1 has a curved interface S, which is located on the side opposite to the body 2 and is used to transmit or receive a plurality of ultrasonic signals Ve. Specifically, in this embodiment, the curved interface S is all or at least part of the surface of the ultrasonic transducer 1 facing the side opposite to the body 2. When the emitted ultrasonic signal Ve reaches an obstacle, multiple reflected ultrasonic signals will be generated. The body 2 may include circuits for signal detection or other type of processing to receive and process the ultrasonic signal Ve received by the ultrasonic transducer 1.

As shown in FIG. 1B, the inner surface of the ultrasonic transducer 1 is used to connect with the body 2, and the curved interface S is used to receive or transmit the ultrasonic signal Ve. In this embodiment, the curved interface S can be regarded as a convex curved surface formed by bending the long sides and the short sides of a long rectangle into curved sides respectively. As shown in FIG. 1B, the first side 11 of the curved interface S can be a long side, and the first side 11 includes a first curve 11a. The second side 12 adjacent to the first side can be a short side, and the second side 12 includes a second curve 12a. The first curve 11a and the second curve 12a intersect, and the curvature of the first curve 11a is different from the curvature of the second curve 12a. For example, the curvature of the first curve 11a can be greater than the curvature of the second curve 12a. As shown in FIG. 1B, in this embodiment, the first curve 11a is a curve that extends along the long arc side of the curved interface S, and the second curve 12a is a curve that extends along the short arc side of the curved interface S. In addition, the body 2 has intersecting long side L1 and short side D1. The first curve 11a extends in a curved manner along the long side L1, and the second curve 12a extends in a curved manner along the short side D1. Secondly, the width of the ultrasonic transducer 1 can be less than or equal to the width of the short side D1 of the body 2. In this embodiment, the first curve 11a is the long axis of the ultrasonic transducer 1, and the second curve 12a is the short axis of the ultrasonic transducer. Therefore, the ultrasonic transducer uses the double-curvature long and short axis design of the first curve and the second curve, or, in another embodiment, a multi-curvature design, to amplify the range of measurement using ultrasonic signals.

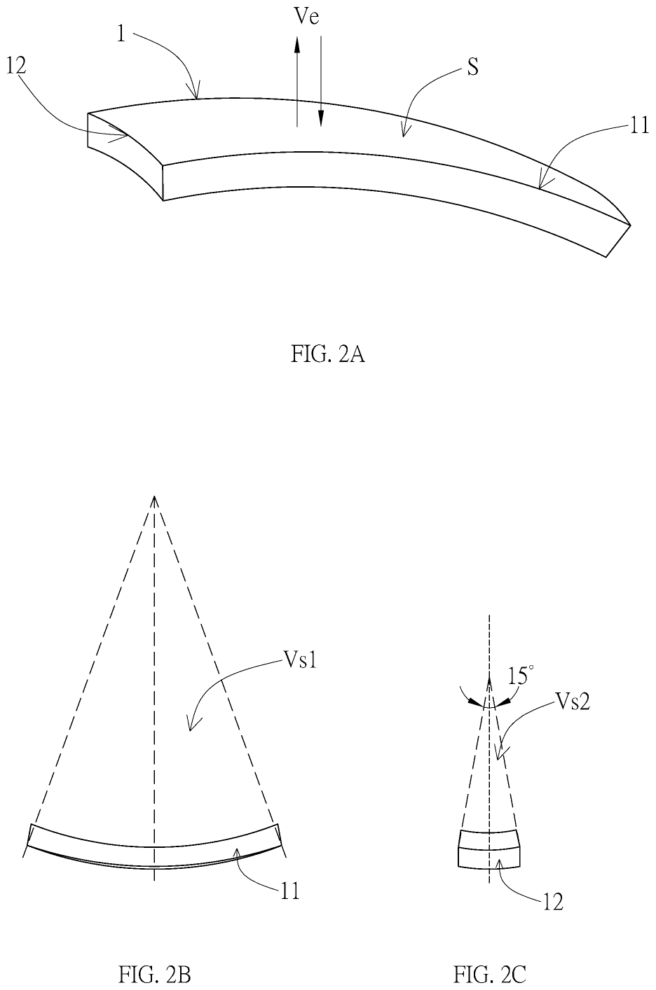

FIG. 2A shows a perspective view of the ultrasonic transducer. FIG. 2B shows the top view of the ultrasonic transducer, and FIG. 2C shows the side view of the ultrasonic transducer. As shown in FIGS. 2B and 2C, the underwater ultrasonic device has different curvatures on different cross-sections and tangent lines. As shown in FIGS. 2B and 1B, the first curve 11a is the boundary line between the curved interface S and the first virtual cross-section Vs1, and the central angle corresponding to the first curve 11a is an acute angle, and the first curve 11a has a plurality of different curvatures on the curve. In this embodiment, the beam angle of the first curve 11a is preferably between 115 degrees and 125 degrees, but it is not limited thereto. As shown in FIGS. 2C and 1B, the second curve 12a is the boundary line between the curved interface S and the second virtual cross-section Vs₂, the central angle corresponding to the second curve 12a is an acute angle, and the second curve 12a has a plurality of different curvatures on the curve. In this embodiment, the optimal angle of the central angle corresponding to the second curve 12a is 15 degrees. It can be seen from FIGS. 1B, 2B and 2C that the first virtual cross-section Vs1 is perpendicular to the second virtual cross-section Vs2, and the average curvatures of the first curve 11a and the second curve 12a are different. The curvature of the second curve 12a is greater than the curvature of the first curve 11a.

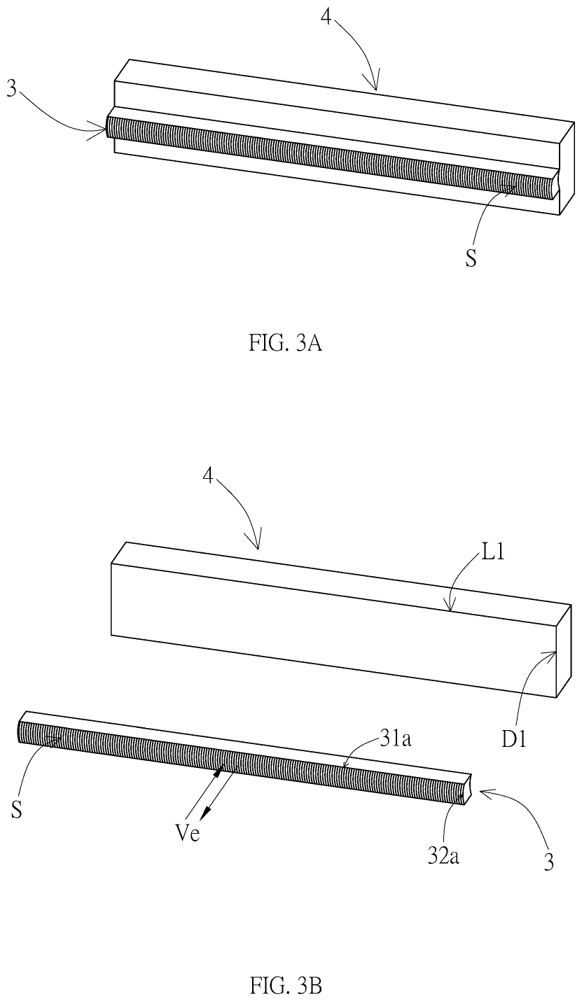

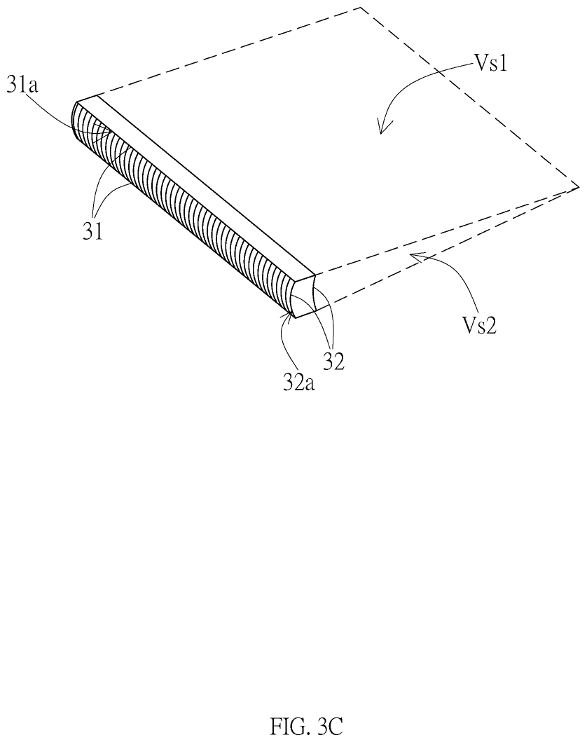

FIG. 3A and FIG. 3B show an underwater ultrasonic device according to another embodiment of the present invention. FIG. 3A shows the diagram of the ultrasonic transducer in connection with the body. FIG. 3B shows a diagram of the ultrasonic transducer separated from the body. FIG. 3C shows the boundary line of the underwater ultrasonic device of the present invention. As shown in FIG. 3A and FIG. 3B, the underwater ultrasonic device includes: an ultrasonic transducer 3 and a body 4 connected to the ultrasonic transducer 3. The body 4 has a supporting surface, and the ultrasonic transducer is arranged on the supporting surface of the body 4 and transmits and receives signals on the side opposite to the supporting surface, wherein the supporting surface may be a flat surface or a curved surface. The ultrasonic transducer 3 has a curved interface S located on the side opposite to the body 4 for transmitting or receiving a plurality of ultrasonic signals Ve. When the emitted ultrasonic signal Ve reaches an obstacle, multiple reflected ultrasonic signals will be generated. The body 4 may be a long-strip type of object, and the body 4 may include circuits for signal detection or other type of processing to receive and process the ultrasonic signal Ve received by the ultrasonic transducer 3. The straight-line type ultrasonic transducer in this embodiment belongs to a phased array ultrasonic transducer.

As shown in FIG. 3, one side of the curved interface S is used to connect with the body 4, and the other side is used to receive or transmit the ultrasonic signal Ve. The curved interface S has a first boundary line 31a and a second boundary line 32a. The first boundary line 31a intersects with the second boundary line 32a, and at least one of the first boundary line 31a and the second boundary line 32a is a curve, and this curve has a plurality of different curvatures. In this embodiment, the first boundary line 31a may be a straight line, the second boundary line 32a may be a curve, and the body 4 has intersecting long side L1 and short side D1. The first boundary line 31a (straight line) extends in a straight line along the long side L1, and the second boundary line (curve) 32a extends in a curved manner along the short side D1. Secondly, the width of the ultrasonic transducer 3 can be less than or equal to the width of the short side D1 of the body 4, and its length can be less than or equal to the length of the long side L1 of the body 4. In this embodiment, the ultrasonic transducer adopts the design of a straight-line long axis and a curved short axis, which can improve the sensitivity of the ultrasonic transducer.

FIG. 3C shows the boundary line of the underwater ultrasonic device of the present invention. As shown in FIG. 3C, the curved interface S has a first side 31 and a second side 32 adjacent to the first side. The straight line 31a is the first boundary line between the curved interface S and the first virtual cross-section Vs1. The first side 31 of the curved interface S and the first virtual cross-section Vs1 has a first boundary line 31a, and the curve 32a is the second boundary line between the curved interface S and the second virtual cross-section Vs2. The second side 32 of the curved interface S and the second virtual cross-section Vs2 has a second boundary line 32a. The first virtual cross-section Vs1 is perpendicular to the second virtual cross-section Vs2. The two ends of the curve 32a intersect in a distance. The angle formed by the intersecting lines is an acute angle, and the best angle is 15 degrees.

To sum up, the present invention uses arc-shaped ultrasonic transducers with transmitting or receiving capabilities underwater which has the characteristics of long and short axes with double curvature or multiple curvatures to measure ultrasonic signals in a wide-angle range. In addition, the present invention can also be applied to a straight-line type of ultrasonic transducer designed with a straight-line long axis and a curved short axis to improve the sensitivity of the ultrasonic transducer.

The content disclosed above is only the preferred and feasible embodiments of the present invention, which does not limit the scope of the patent application of the present invention. Therefore, all equivalent technical changes made using the description and schematic content of the present invention fall into the patent application scope of the present invention.

What is claimed is:

1. An underwater ultrasonic device, comprising:
a body; and
an ultrasonic transducer, arranged on the body, having a curved interface for transmitting or receiving a plurality of ultrasonic signals, wherein the curved interface has a first side and a second side adjacent to the first side, and the first side has a first curve, the second side has a second curve, wherein the first curve and the second curve have different curvatures.

2. The underwater ultrasonic device according to claim 1, wherein the first curve is a first common boundary between the curved interface and a first virtual cross-section, and the second curve is a second common boundary between the curved interface and a second virtual cross-section, the first virtual cross-section is perpendicular to the second virtual cross-section.

3. The underwater ultrasonic device according to claim 1, wherein the underwater ultrasonic device has a long side and a short side intersected the long side, the first curve extends along the long side, the second curve extends along the short side, wherein the curvature of the second curve is greater than the curvature of the first curve.

4. The underwater ultrasonic device according to claim 1, wherein the first curve or the second curve has a plurality of different curvatures

5. The underwater ultrasonic device according to claim 1, wherein average curvatures of the first curve and the second curve are different.

6. The underwater ultrasonic device according to claim 1, wherein a beam angle of the first curve is between 115 degrees and 125 degrees.

7. An underwater ultrasonic device, comprising:
a body; and
an ultrasonic transducer, arranged on the body, wherein the ultrasonic transducer has a curved interface for transmitting or receiving a plurality of ultrasonic signals, wherein there is a first boundary line between a first side of the curved interface and a first virtual cross-section, and there is a second boundary line between a second side of the curved interface and a second virtual cross-section, and the first side is adjacent to the second side;
wherein, at least one of the first boundary line and the second boundary line is curve.

8. The underwater ultrasonic device according to claim 7, wherein the underwater ultrasonic device has a long side and a short side intersected the long side, the first boundary line extends along the long side, and the second boundary line extends along the short side, wherein the second side is the short side and the second boundary line is a curve.

9. The underwater ultrasonic device according to claim 7, wherein the first virtual cross-section is perpendicular to the second virtual cross-section.

10. The underwater ultrasonic device according to claim 7, wherein the curve has a plurality of different curvatures.
